(19) United States
(12) Patent Application Publication
(10) Pub. No.: US 2026/0336677 A1
(43) Pub. Date: Oct. 29, 2026

(54) Detachable Equipment Carrier

(71) Applicant: LaxCaddy, LLC, Phoenix, AZ (US)

(72) Inventors: Connor Whalin, Phoenix, AZ (US); Christine Whalin, Phoenix, AZ (US); Cory Whalin, Phoenix, AZ (US)

(21) Appl. No.: 19/656,909

(22) Filed: Apr. 23, 2026

Related U.S. Application Data
(60) Provisional application No. 63/793,505, filed on Apr. 23, 2025.

(51) Int. Cl. B62B 3/10; A63B 60/56; A63B 102/14; B62B 3/02

(52) U.S. Cl. CPC B62B 3/102; A63B 60/56; B62B 3/02; A63B 2102/14

(57) ABSTRACT

An equipment carrier is disclosed for detachable mounting to a cart or wagon. The equipment carrier includes a body having a forward portion, a top portion, and a back portion, with the forward and back portions coupled to the top portion and extending substantially parallel to one another to define a channel sized to engage a side wall of the cart or wagon. A first retaining mechanism is coupled to the back portion, and a second retaining mechanism is coupled to the back portion and vertically aligned with the first retaining mechanism to receive and retain sporting equipment. In various embodiments, the retaining mechanisms include one or more of captive holes, shelves, and hooks, and additional vertically aligned retaining mechanisms may be provided.

### CROSS REFERENCE TO RELATED APPLICATIONS

The present application claims priority to and the benefit of U.S. Ser. No. 63/793,505 filed on Apr. 23, 2025, which is incorporated by reference in its entirety for all purposes.

### FIELD

The present disclosure relates to sports equipment carriers. More particularly, the present disclosure relates to detachable equipment carriers that can be removably installed on carts and wagons.

### BACKGROUND

Sports like lacrosse and baseball are popular sports that requires players to carry multiple pieces of equipment, including poles, sticks, bats, pads, and other accessories. Traditionally, players have struggled with transporting these items efficiently and securely, especially when moving between practice sessions, games, and other events. Existing solutions, such as bags and traditional carriers, often lack the necessary features to accommodate the unique shape and size of sports equipment, leading to inconvenience and potential damage to the equipment.

### SUMMARY

In various embodiments, an equipment carrier includes a body having a forward portion, a top portion, and a back portion, with the forward and back portions coupled to the top portion and extending substantially parallel to one another so as to define a channel sized to be received on a side wall of a cart or wagon. The equipment carrier further includes a first retaining mechanism operatively coupled to the back portion and a second retaining mechanism operatively coupled to the back portion and vertically aligned with the first retaining mechanism to receive and retain sporting equipment. In further embodiments, the retaining mechanisms may include one or more of captive holes, shelves, hooks, clips, U-bolts, or other fasteners, and additional retaining mechanisms may be provided in vertically aligned pairs. The body may be formed as an assembly or as a monolithic structure, and the equipment carrier may be removably installable on the cart or wagon to facilitate transport and organized storage of sporting equipment and accessories.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the detailed description and claims when considered in connection with the drawing figures, wherein like numerals denote like elements.

FIG. 1 illustrates a side perspective view of a detachable equipment carrier mounted on a wagon, in accordance with various embodiments.

FIG. 2 illustrates a back view of a detachable equipment carrier mounted on a wagon, in accordance with various embodiments.

FIG. 3 illustrates a side perspective view of a detachable equipment carrier, in accordance with various embodiments.

### DETAILED DESCRIPTION

The detailed description of exemplary embodiments herein makes reference to the accompanying drawings, which show exemplary embodiments by way of illustration. While these exemplary embodiments are described in sufficient detail to enable those skilled in the art to practice the inventions, it should be understood that other embodiments may be realized and that logical, chemical and mechanical changes may be made without departing from the spirit and scope of the inventions. Thus, the detailed description herein is presented for purposes of illustration only and not of limitation. For example, the steps recited in any of the method or process descriptions may be executed in any order and are not necessarily limited to the order presented. Furthermore, any reference to singular includes plural embodiments, and any reference to more than one component or step may include a singular embodiment or step. Also, any reference to attached, fixed, connected or the like may include permanent, removable, temporary, partial, full and/or any other possible attachment option. Additionally, any reference to without contact (or similar phrases) may also include reduced contact or minimal contact.

There is a need in the art for an improved equipment carrier specifically designed for lacrosse poles and/or baseball equipment. Such a carrier should provide secure retention, ease of transport, and compatibility with various modes of transportation, such as carts and wagons. The present disclosure addresses these needs by offering a detachable equipment carrier that can be removably installed on carts and wagons, providing a practical and efficient solution for lacrosse or baseball players.

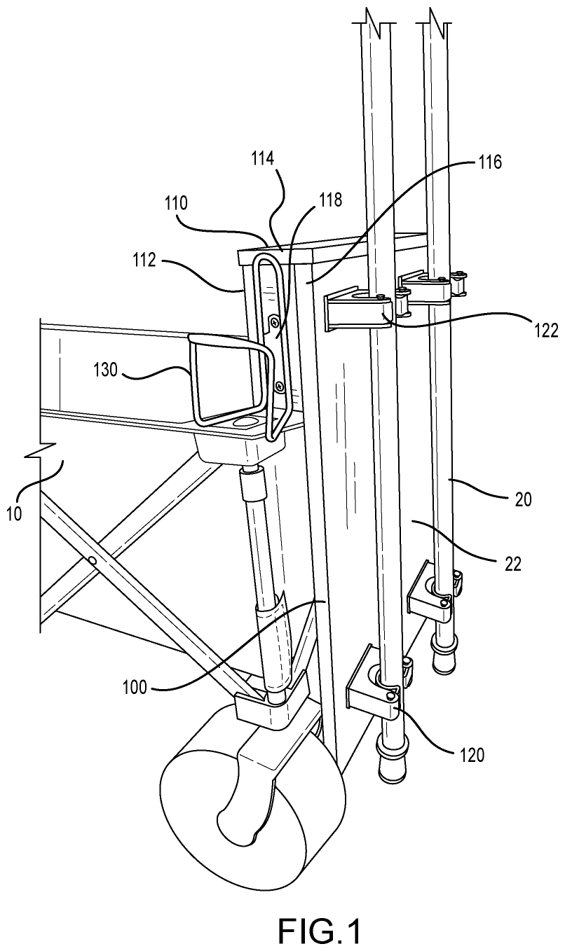

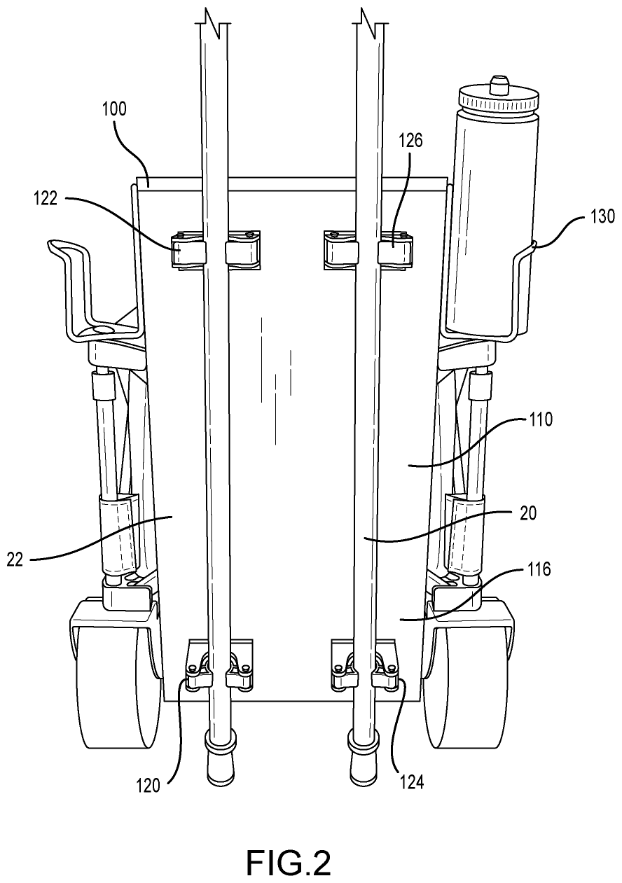

In various embodiments and with reference to FIG. 1 and FIG. 2, an equipment carrier 100 may be configured to hold various pieces of sports equipment. Equipment carrier 100 may also be configured to mount to a cart or wagon 10. Equipment carrier 100 may comprise a body 110. Body 110 may be an assembly. Body 110 may also be a monolithic structure.

Body 110 may comprise a forward portion 112. Forward portion 112 may be coupled to top portion 114. Top portion 114 may be operatively coupled to a back portion 116. In this regard, body 110 may have at least a partial U-profile. Body 110 may define a channel 118 bounded by forward portion 112, top portion 114, and back portion 116. Channel 118 may be sized to be removably mounted to a wagon or cart 10. Back portion 116 may define a mounting surface for any number of items, including for example, hooks, decals, and/or the like.

In various embodiments, equipment carrier 100 may comprise one or more retention brackets, including for example, first retention bracket 120, second retention bracket 122, third retention bracket 124, and fourth retention bracket 126, and/or the like. The one or more retention brackets may be configured to receive and retain sporting equipment, such as, for example, lacrosse stick 20 and lacrosse stick 22. Equipment carrier 100 may be configured to receive and retain sporting equipment of various lengths.

First retention bracket 120 and second retention bracket 122 may be operatively coupled to back portion 116. First retention bracket 120 and second retention bracket 122 may be vertically aligned with one another. Similarly, third retention bracket 124 and fourth retention bracket 126 may be operatively coupled to back portion 116. Third retention bracket 124 and fourth retention bracket 126 may be vertically aligned with one another. Moreover, each pair a vertically aligned brackets may also be substantially parallel to the other pair.

In various embodiments, equipment carrier 100 may be configured with one or more mounting devices and/or hooks, such as for example, one or more water bottle carriers 130.

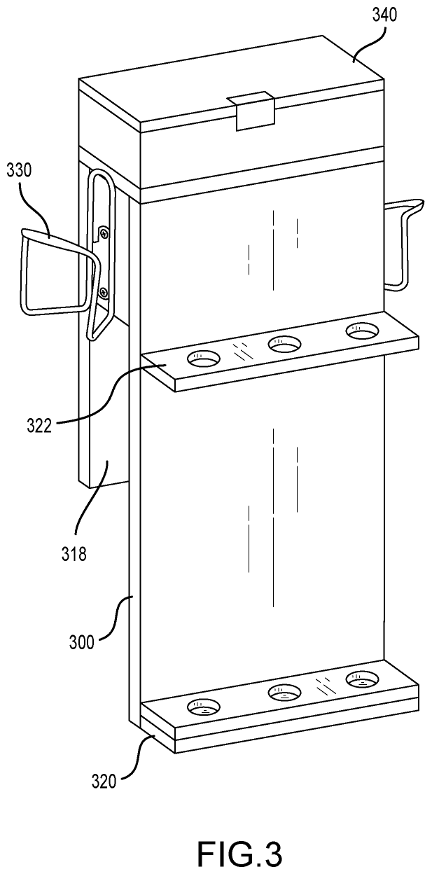

In various embodiments and with reference to FIG. 3, equipment carrier 300 may include the forward portion, top portion and back portion discussed herein. It may similarly define a channel that is mountable on a cart or wagon. Equipment carrier 300 may comprise a support shelf 320 disposed at an end of the back portion. Support shelf 320 may protrude from the back portion and may be substantially perpendicular to the back portion. Support shelf 320 may comprise one or more recessed holes sized to receive a portion of a piece of sporting equipment, such as for example, a lacrosse pole.

Equipment carrier 300 may also comprise a retention shelf 322 disposed on the back portion above support shelf 320. Retention shelf 322 may protrude from the back portion and may be substantially perpendicular to the back portion. Retention shelf 322 may also be substantially parallel to support shelf 320. Retention shelf 322 may comprise one or more through holes. Each of the through holes may be sized to receive and retain a piece of sporting equipment, such as for example, a lacrosse pole. Each of through holes in retention shelf 322 may be aligned with each of the recessed holes support shelf 320. As an alternative to through holes and shelf 322, equipment carrier 300 may comprise one or more, hooks, clips, U-bolts, or other suitable fasteners that are configured to receive and retain lacrosse poles.

Equipment carrier 300 may also comprise a caddy 340 operatively coupled to the top portion. Caddy 340 may define a retention volume between four sidewalls and may have an open top. Caddy 340 may be sized to hold sporting equipment, personal items, and/or the like. For example, caddy 340 may be sized to hold a lacrosse ball, a baseball, a water bottle or other personal items.

After reading the present disclosure, one of ordinary skill will appreciate that the various seal features described herein may be combined in various ways without departing from the scope of the present disclosure.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

Systems, methods and apparatus are provided herein. In the detailed description herein, references to “one embodiment”, “an embodiment”, “various embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f), unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. An equipment carrier, comprising:
a body comprising a forward portion, a top portion, and a back portion, the forward portion and the back portion are coupled to the top portion and are substantially parallel to one another;
a first retaining mechanism operatively coupled to the back portion;
a second retaining mechanism operatively couples to the back portion, the second retaining mechanism is vertically aligned with the second retaining mechanism.

2. The equipment carrier of claim 1, wherein the body is an assembly.

3. The equipment carrier of claim 1, wherein the body is monolithic.

4. The equipment carrier of claim 1, wherein the first retaining mechanism is a captive hole.

5. The equipment carrier of claim 1, wherein the second retaining mechanism is a shelf.

6. The equipment carrier of claim 1, wherein the first retaining mechanism and the second retaining mechanism are hooks.

7. The equipment carrier of claim 1, further comprising a third retaining mechanism and a fourth retaining mechanism, the fourth retaining mechanism is vertically aligned with the third retaining mechanism.

8. The equipment carrier of claim 7, wherein the third retaining mechanism and the fourth retaining mechanism are substantially parallel to the first retaining mechanism and the second retaining mechanism.

9. The equipment carrier of claim 1, wherein the body defines a partial U shape between the forward portion, the top portion and the back portion.

10. The equipment carrier of claim 9, wherein the body is installable on a wagon.

11. An equipment transport system, comprising;
a cart having at least one side wall;
an equipment carrier operatively coupled to the cart, the equipment carrier comprising:
a first retaining mechanism;
a second retaining mechanism, the second retaining mechanism is vertically aligned with the second retaining mechanism.

12. The equipment transport system of claim 11, wherein the equipment carrier is defined in the side wall.

13. The equipment transport system of claim 12, wherein the first retaining mechanism is defined in the side wall.

14. The equipment transport system of claim 11, wherein the equipment carrier is removably installed on the side wall of the cart.

15. The equipment transport system of claim 11, wherein the equipment carrier comprises a body comprising a forward portion, a top portion, and a back portion, the forward portion and the back portion are coupled to the top portion and are substantially parallel to one another.
